(19) United States
(12) Patent Application Publication
(10) Pub. No.: US 2012/0211611 A1
(43) Pub. Date: Aug. 23, 2012

(54) CLAMP STRUCTURE CAPABLE OF PREVENTING A PLANK THEREOF FROM BENDING

(76) Inventors: Ming-Chan Lee, Hsinchu (TW); Lan-Chun Yang, Hsinchu (TW); Hung-Yuan Lin, Hsinchu (TW); San-Yi Kuo, Hsinchu (TW); Wei-Te Chien, Hsinchu (TW)

(21) Appl. No.: 13/083,593

(22) Filed: Apr. 10, 2011

(30) Foreign Application Priority Data
Feb. 22, 2011 (TW) 100105755

(51) Int. Cl. F16L 3/08

(52) U.S. Cl. 248/74.1

(57) ABSTRACT

A clamp structure capable of preventing a plank thereof from bending is disclosed in the present invention. The clamp structure includes a clamping portion, two planks connecting to two edges of the clamping portion, at least one fixing component set passing through the planks for closing the two planks, a contacting portion disposed on one of the planks, and a stopping portion disposed on the other plank and located in a position adjacent to the contacting portion. The contacting portion contacts against the other plank when the planks is to be closed. The stopping portion stops a lateral surface of the contacting portion for preventing the contacting portion from bending relative to the planks when the contacting portion contacts against the other plank.

### BACKGROUND OF THE INVENTION

1. Field of the Invention

The present invention relates to a clamp structure, and more particularly, to a clamp structure capable of preventing a plank from bending.

2. Description of the Prior Art

A conventional clamp structure includes a clamping portion, two planks and a contacting portion. The clamping portion is for covering a tube, and a fixing component passes through and locks the two planks, so as to close the two planks and to increase strength of the clamping portion on the tube. When the two planks are to be close at a predetermined distance, the contacting portion disposed on the plank contacts against the other plank for stable constrain. However, the contacting portion of the conventional clamp structure may be deformed easily by the other plank due to overlarge strength of the fixing component on the two planks, and it results the conventional clamp structure can not clamp the tube tightly. Thus, design of a clamp structure capable of preventing the contacting portion from bending by external force is an important issue of the mechanical industry.

### SUMMARY OF THE INVENTION

The present invention provides a clamp structure capable of preventing a plank from bending for solving above drawbacks.

According to the claimed invention, a clamp structure includes a clamping portion for clamping a supporting tube in a enclosed manner, two planks respectively connecting to two edges of the clamping portion, at least one fixing component set passing through the two planks for closing the two planks so as to increase clamping force of the clamping portion applied on the supporting tube, a contacting portion disposed on one of the two planks for contacting against the other plank of the two planks when a distance between the two planks are closed, and a stopping portion disposed on the other plank of the two planks and located in a position adjacent to the contacting portion for stopping a lateral surface of the contacting portion when the contacting portion contacts against the other plank, so as to prevent the contacting portion from bending relative to the planks.

According to the claimed invention, the fixing component set includes a screw passing through the two planks, and a nut locking on an end of the screw.

According to the claimed invention, the stopping portion is a protruding structure.

According to the claimed invention, the protruding structure is a strip protruding structure, and a length of the strip protruding structure is substantially equal to a length of the contacting portion.

According to the claimed invention, the protruding structure includes a plurality of protrusions, and a length of each protrusion is substantially less than a length of the contacting portion.

According to the claimed invention, the stopping portion is a sunken structure for engaging with the contacting portion.

According to the claimed invention, the sunken structure is a strip sunken slot, and dimensions of the strip sunken slot are substantially equal to dimensions of the contacting portion.

According to the claimed invention, the sunken structure comprises a plurality of holes, the contacting portion comprises a plurality of engaging parts for respectively engaging inside the corresponding holes, and dimensions of each engaging part are substantially equal to dimensions of each hole.

According to the claimed invention, the clamp structure is for fixing an antenna module on the supporting tube.

The present invention disposes the stopping portion on the plank, and disposes the contacting portion on the other plank. The stopping portion of the present invention is disposed by the outer side of the contacting portion, and the stopping portion can contact against the outer surface of the contacting portion when the contacting portion contacts against the plank, so as to prevent the contacting portion from bending. Thus, the prevent invention can effectively strengthen clamping function of the clamp structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a clamp structure according to a first embodiment of the present invention.

FIG. 2 is a top view of the clamp structure according to the first embodiment of the present invention.

FIG. 3 is a diagram of the clamp structure according to a second embodiment of the present invention.

FIG. 4 is a diagram of the clamp structure according to a third embodiment of the present invention.

### DETAILED DESCRIPTION

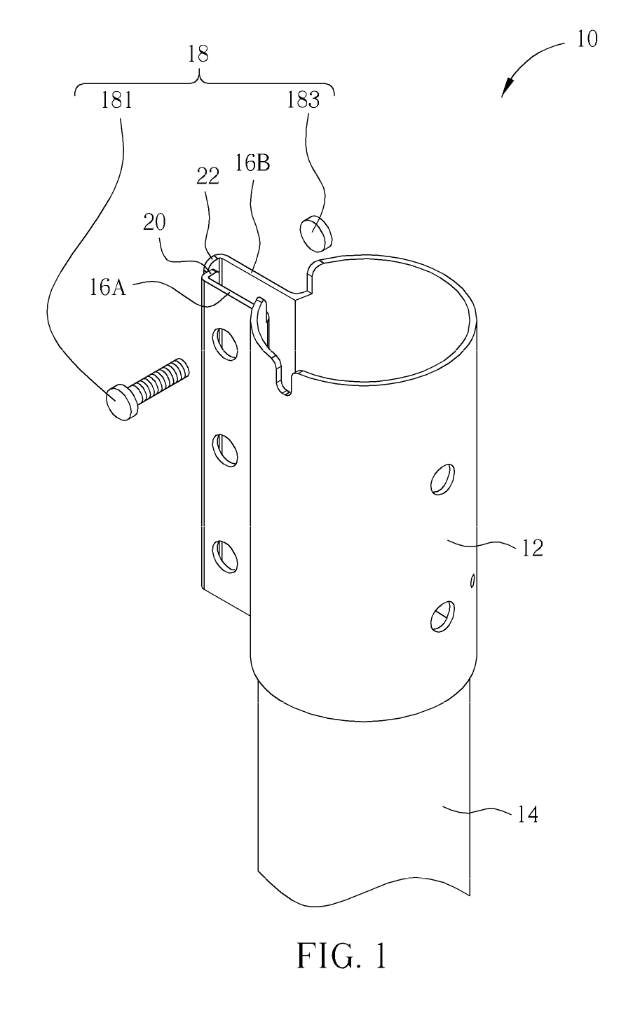

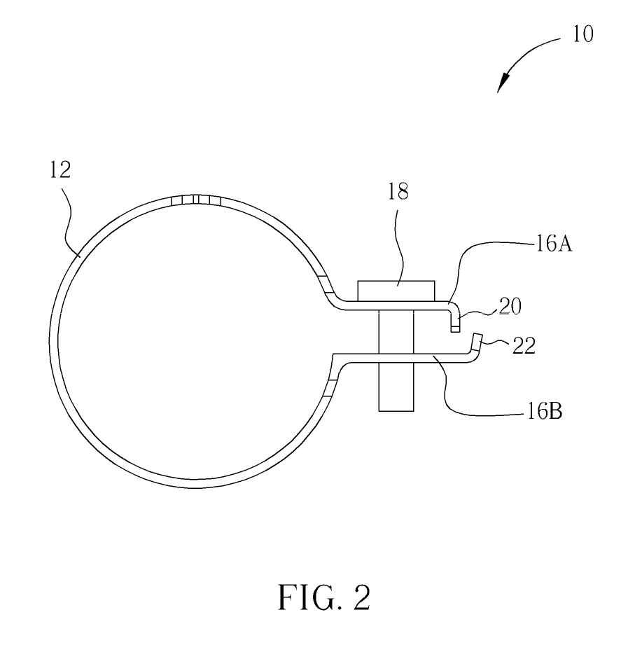

Please refer to FIG. 1 and FIG. 2. FIG. 1 is a diagram of a clamp structure 10 according to a first embodiment of the present invention. FIG. 2 is a top view of the clamp structure 10 according to the first embodiment of the present invention. The clamp structure 10 is for fixing an antenna module on a supporting tube. The clamp structure 10 includes a clamping portion 12 for clamping a supporting tube 14 in an enclosed manner, two planks 16A, 16B respectively connecting to two edges of the clamping portion 12, and at least one fixing component set 18 passing through the two planks 16A, 16B for closing the two planks 16A, 16B, so as to increase clamping strength of the clamping portion 12 applied on the supporting tube 14. Structure and function of the plank 16A are identical to structure and function of the plank 16B. The clamp structure 10 further includes a contacting portion 20 disposed on the plank 16A, and a stopping portion 22 disposed on the plank 16B and located in a position adjacent to the contacting portion 20.

In addition, the fixing component set 18 can include a screw 181 passing through the two planks 16A, 16B, and a nut 183 locking on an end of the screw 181. When the fixing component set 18 is locked on the two planks 16A, 16B for closing the two planks 16A, 16B, the contacting portion 20 contacts against an inner surface of the plank 16B. Meanwhile, the stopping portion 22 is for contacting against an outer lateral surface of the contacting portion 20 for preventing the contacting portion 20 from bending relative to the two planks 16A, 16B, so that the stopping portion 22 can prevent the contacting portion 20 from deforming relative to the plank 16A effectively.

In the first embodiment of the present invention, the stopping portion 22 of the clamp structure 10 can be a protruding structure, such as a strip protruding structure, and a length of the strip protruding structure is substantially equal to a length of the contacting portion 20, so that the strip protruding structure can stop the contacting portion 20 for preventing the contacting portion 20 from bending relative to the plank 16A when the contacting portion 20 contacts against the plank 16B. It should be mentioned that a structure of the stopping portion 22 is not limited to the first embodiment, and it depends on design demand. For example, the stopping portion 22 can include a plurality of protrusions, and a length of each protrusion is substantially less than the length of the contacting portion 20. The protrusions are respectively for contacting against different sections of the contacting portion 20, so as to prevent the contacting portion from bending relative to the plank 16A.

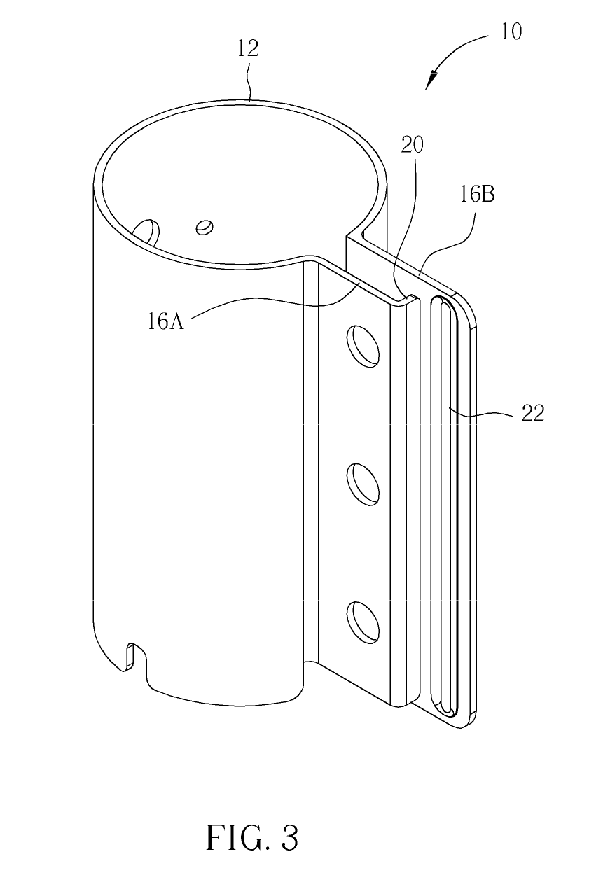

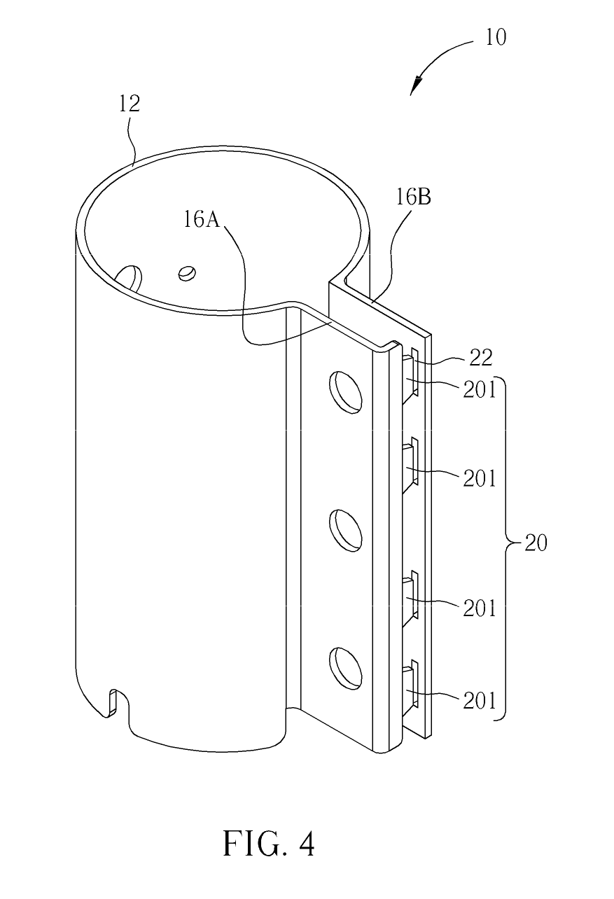

Please refer to FIG. 3 and FIG. 4. FIG. 3 is a diagram of the clamp structure 10 according to a second embodiment of the present invention. FIG. 4 is a diagram of the clamp structure 10 according to a third embodiment of the present invention. In the second embodiment and the third embodiment, functions of the clamp structure 10 are identical to functions of the clamp structure 10 in the first embodiment, and detailed description is omitted herein for simplicity. As shown in FIG. 3, the stopping portion 22 of the clamp structure 10 can be a sunken structure, such as a strip sunken slot, for engaging with the contacting portion 22. Dimensions of the strip sunken slot can be substantially equal to dimensions of the contacting portion 20, so that the contacting portion 20 can be engaged inside the strip sunken slot entirely when the two planks 16A, 16B are close, so as to prevent the contacting portion 20 from bending relative to the plank 16A. As shown in FIG. 4, the stopping portion 22 of the clamp structure 10 can be the sunken structure having a plurality of holes, and the contacting portion 20 can include a plurality of engaging parts 201. Dimensions of each engaging part 201 can be substantially equal to dimensions of each hole. When the two planks 16A, 16B are close, the engaging parts 201 of the contacting portion 20 can respectively be engaged inside the corresponding holes, so that that contacting portion 20 does not bend relative to the plank 16A by the external force. In conclusion, structures of utilizing the stopping portion 22 to contact against the outer surface of the contacting portion 20 for preventing the contacting portion 20 from deforming when the contacting portion 20 contacts against the planks 16A, 16B belong to the scope of the prevent invention.

Comparing to the prior art, the present invention disposes the stopping portion on the plank, and disposes the contacting portion on the other plank. The stopping portion of the present invention is disposed by the outer side of the contacting portion, and the stopping portion can contact against the outer surface of the contacting portion when the contacting portion contacts against the plank, so as to prevent the contacting portion from bending. Thus, the prevent invention can effectively strengthen clamping function of the clamp structure.

Those skilled in the art will readily observe that numerous modifications and alterations of the device and method may be made while retaining the teachings of the invention.

What is claimed is:

1. A clamp structure comprising:
a clamping portion for clamping a supporting tube in a enclosed manner;
two planks respectively connecting to two edges of the clamping portion;
at least one fixing component set passing through the two planks for closing the two planks so as to increase clamping force of the clamping portion applied on the supporting tube;
a contacting portion disposed on one of the two planks for contacting against the other plank of the two planks when a distance between the two planks are closed; and
a stopping portion disposed on the other plank of the two planks and located in a position adjacent to the contacting portion for stopping a lateral surface of the contacting portion when the contacting portion contacts against the other plank, so as to prevent the contacting portion from bending relative to the planks.

2. The clamp structure of claim 1, wherein the fixing component set comprises:
a screw passing through the two planks; and
a nut locking on an end of the screw.

3. The clamp structure of claim 1, wherein the stopping portion is a protruding structure.

4. The clamp structure of claim 3, wherein the protruding structure is a strip protruding structure, and a length of the strip protruding structure is substantially equal to a length of the contacting portion.

5. The clamp structure of claim 3, wherein the protruding structure comprises a plurality of protrusions, and a length of each protrusion is substantially less than a length of the contacting portion.

6. The clamp structure of claim 1, wherein the stopping portion is a sunken structure for engaging with the contacting portion.

7. The clamp structure of claim 6, wherein the sunken structure is a strip sunken slot, and dimensions of the strip sunken slot are substantially equal to dimensions of the contacting portion.

8. The clamp structure of claim 6, wherein the sunken structure comprises a plurality of holes, the contacting portion comprises a plurality of engaging parts for respectively engaging inside the corresponding holes, and dimensions of each engaging part are substantially equal to dimensions of each hole.

9. The clamp structure of claim 1, wherein the clamp structure is for fixing an antenna module on the supporting tube.
